(19) United States
(12) Patent Application Publication
(10) Pub. No.: US 2026/0181247 A1
(43) Pub. Date: Jun. 25, 2026

(54) USING ARTIFICIAL INTELLIGENCE TO IMPROVE PHOTOGRAPHY EXPERIENCES

(71) Applicants: Sony Group Corporation, Tokyo (JP); Sony Interactive Entertainment LLC, San Mateo, CA (US)

(72) Inventors: James R. Milne, Ramona, CA (US); True Xiong, San Diego, CA (US); Clay Fisher, San Diego, CA (US)

(73) Assignees: Sony Group Corporation, Tokyo (JP); Sony Interactive Entertainment LLC, San Mateo, CA (US)

(21) Appl. No.: 19/000,155

(22) Filed: Dec. 23, 2024

(51) Int. Cl. H04N 23/60; H04N 23/62; H04N 23/63

(52) U.S. Cl. CPC H04N 23/64; H04N 23/62; H04N 23/631

(57) ABSTRACT

In some implementations, a method includes receiving, at a server, environment data. The method further includes providing the environment data to one or more machine-learning models. The method further includes receiving one or more candidate camera settings from the one or more machine-learning models, where the one or more candidate camera settings are based on the environment data. The method further includes displaying the one or more candidate camera settings in a user interface of a camera device, where the one or more candidate camera settings guide a user in improving a quality level of one or more images captured by the camera device. The method further includes modifying the one or more camera settings of the camera device based on the one or more candidate camera settings.

### BACKGROUND

Photography can be a challenging and complex activity, especially with more advanced cameras where a user selects various camera parameters to take pictures. As hardware gets increasingly complicated, users may struggle with using cameras and connected camera accessories and understanding how to best work with the camera and any attached accessories. For example, a neutral density filter that is attached to a camera lens work best if the shutter speed is reduced by half of the camera's previous shutter speed. A user may find it difficult to identify the camera's current shutter and calculate a new shutter speed manually, and ultimately set the camera settings.

### SUMMARY

Implementations generally relate to photography. In some implementations, a system includes one or more processors, and includes logic encoded in one or more non-transitory computer-readable storage media for execution by the one or more processors. When executed, the logic is operable to cause the one or more processors to perform operations including: receiving, at a server, environment data; providing the environment data to one or more machine-learning models; receiving one or more candidate camera settings from the one or more machine-learning models, where the one or more candidate camera settings are based on the environment data; displaying the one or more candidate camera settings in a user interface of a camera device, where the one or more candidate camera settings guide a user in improving a quality level of one or more images captured by the camera device; and modifying the one or more camera settings of the camera device based on the one or more candidate camera settings.

With further regard to the system, in some implementations, the environment data is associated with one or more of a location and a time of day. In some implementations, the one or more candidate camera settings include one or more of compositions and lens settings. In some implementations, the one or more candidate camera settings include one or more flash setups. In some implementations, the one or more candidate camera settings include one or more of filter effects and exposure aspects. In some implementations, the logic when executed is further operable to cause the one or more processors to perform operations including: receiving a user selection of the one or more candidate camera settings that are displayed in the user interface of the camera; and modifying the one or more camera settings of the camera based on the user selection. In some implementations, the logic when executed is further operable to cause the one or more processors to perform operations including: receiving an input image of a scene captured by the camera device; comparing the input image to one or more other images of the scene that are stored in a database; and modifying the one or more camera settings of the camera based on the comparing. In some implementations, the logic when executed is further operable to cause the one or more processors to perform operations comprising: receiving a user-selected creativity level from the user; and modifying the one or more camera settings based on the user-selected creativity level.

In some implementations, a non-transitory computer-readable storage medium with program instructions thereon is provided. When executed by one or more processors, the instructions are operable to cause the one or more processors to perform operations including: receiving, at a server, environment data; providing the environment data to one or more machine-learning models; receiving one or more candidate camera settings from the one or more machine-learning models, where the one or more candidate camera settings are based on the environment data; displaying the one or more candidate camera settings in a user interface of a camera device, where the one or more candidate camera settings guide a user in improving a quality level of one or more images captured by the camera device; and modifying the one or more camera settings of the camera device based on the one or more candidate camera settings.

With further regard to the computer-readable storage medium, in some implementations, the environment data is associated with one or more of a location and a time of day. In some implementations, the one or more candidate camera settings include one or more of compositions and lens settings. In some implementations, the one or more candidate camera settings include one or more flash setups. In some implementations, the one or more candidate camera settings include one or more of filter effects and exposure aspects. In some implementations, the instructions when executed are further operable to cause the one or more processors to perform operations including: receiving a user selection of the one or more candidate camera settings that are displayed in the user interface of the camera; and modifying the one or more camera settings of the camera based on the user selection. In some implementations, the instructions when executed are further operable to cause the one or more processors to perform operations including: receiving an input image of a scene captured by the camera device; comparing the input image to one or more other images of the scene that are stored in a database; and modifying the one or more camera settings of the camera based on the comparing.

In some implementations, a computer-implemented method includes: receiving, at a server, environment data; providing the environment data to one or more machine-learning models; receiving one or more candidate camera settings from the one or more machine-learning models, the one or more candidate camera settings are based on the environment data; displaying the one or more candidate camera settings in a user interface of a camera device, the one or more candidate camera settings guide a user in improving a quality level of one or more images captured by the camera device; and modifying the one or more camera settings of the camera device based on the one or more candidate camera settings.

With further regard to the method, in some implementations, the environment data is associated with one or more of a location and a time of day. In some implementations, the one or more candidate camera settings include one or more of compositions and lens settings. In some implementations, the one or more candidate camera settings include one or more flash setups. In some implementations, the one or more candidate camera settings include one or more of filter effects and exposure aspects.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example environment improving photography experiences using artificial intelligence (AI), which may be used for implementations described herein.

FIG. 2 is an example flow diagram for improving photography experiences using AI, according to some implementations.

FIG. 3 illustrates example user interfaces for displaying candidate camera parameters and example images, according to some implementations.

FIG. 4 is a block diagram of an example network environment, which may be used for some implementations described herein.

FIG. 5 is a block diagram of an example computer system, which may be used for some implementations described herein.

### DETAILED DESCRIPTION

Implementations described herein utilize artificial intelligences (AI) to improve the photography experiences for users. As described in more detail herein, a system helps novice and advanced users to improve their knowledge and skill in photography. Implementations described herein uses the AI and an associated machine-learning model(s) to pull together all relevant information to provide a user with camera setting suggestions. This gives a user an opportunity to capture great photos and/or videos, thereby enhancing the photography experience for the user.

As described in more detail herein, a system receives, at a server, environment data. The system then provides the environment data to one or more AI machine-learning models, which computes one or more candidate camera settings. The system then receives one or more candidate camera settings from the one or more machine-learning models, where the one or more candidate camera settings are based on the environment data. The system then displays the one or more candidate camera settings in a user interface of a camera device, where the one or more candidate camera settings guide a user in improving a quality level of one or more images captured by the camera device. The system then modifies the one or more camera settings of the camera device based on the one or more candidate camera settings.

Although various implementations disclosed herein is described in the context of photos, these implementations may also apply to video. Example embodiments directed to video are described in more detail herein.

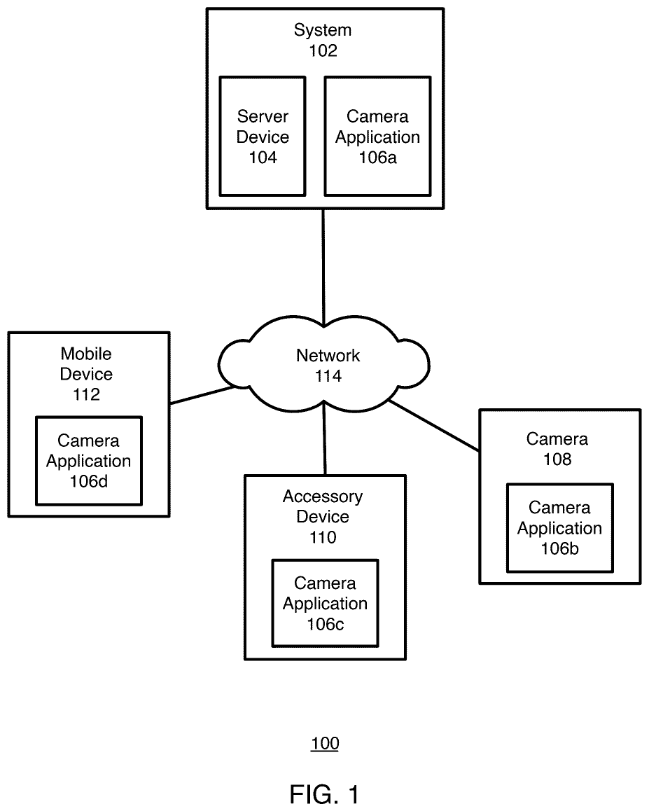

FIG. 1 is a block diagram of an example environment improving photography experiences using AI, which may be used for implementations described herein. In some implementations, environment 100 includes a system 102, a which includes a server device 104 and a camera application 106a. Network environment 100 also includes a camera 108, which also includes a camera application 106b. A “camera” can mean any device which can capture an image or video, regardless of the form or primary function. This could include a still image camera, video camera, mobile phone, security camera, dash cam, etc. Network environment 100 also includes a camera accessory device or accessory device 110, which also includes a camera application 106c. Network environment 100 also includes a mobile device 112, which also includes a camera application 106d. The camera applications 106a, 106b, 106c, and 106d may be referred to collectively as camera application 106. Camera 108, accessory device 110, and mobile device 112 may communicate with system 102 and/or may communicate with each other directly or via system 102. Environment 100 also includes a network 114 through which system 102, camera 108, accessory device 110, and mobile device 112 communicate. Network 114 may be any suitable communication network such as a Bluetooth network, a Wi-Fi network, the Internet, etc.

In various embodiments, there may be some camera accessory devices 110 that have networking capabilities. For example, a flash may support networking capability, whereas a neutral density filter might not have networking support. In various embodiments, the system tracks which camera accessories are compatible with camera 108 and which of those accessories have networking capabilities and which do not.

For ease of illustration, FIG. 1 shows one block for each of system 102, camera 108, accessory device 110, and mobile device 112. Blocks 102, 108, 110, and 112 may represent multiple systems, cameras, accessory devices, and mobile devices. In other implementations, environment 100 may not have all of the components or elements shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein. In some embodiments, the system may be implemented as an external server, as an internal module, or as a combination of the two, depending on available connectivity and other real-time factors. Embodiments described herein may utilize one or more AI machine learning models and/or combinations thereof. Embodiments described herein may utilize alternative implementations where a network connection is unavailable.

In the various implementations described herein, the processor of system 102 causes the elements described herein (e.g., candidate camera settings, example images, photos, etc.) to be displayed in a user interface on one or more display screens.

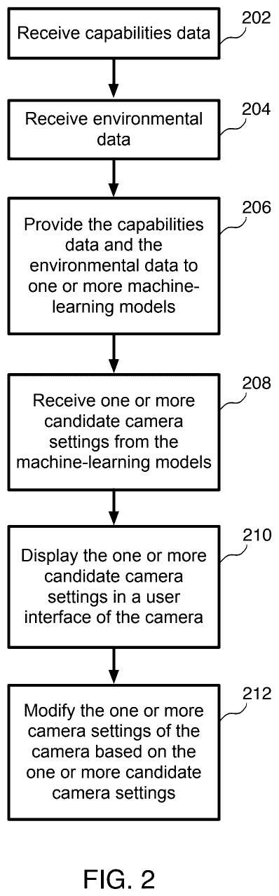

FIG. 2 is an example flow diagram for improving photography experiences using AI, according to some implementations. Referring to both FIGS. 1 and 2, a method is initiated at block 202 where a system such as system 102 receives, at server device 104, capabilities data. The capabilities data include information on the capabilities of the camera 108. These capabilities include features the are built into or integrated into camera 108, such as a built-in flash. These capabilities include features the are built into an accessory device that attached to and/or interacts with camera 108 wirelessly or via a wire or cable. In various embodiments, there may be some camera accessory devices 110 that have networking capabilities. For example, a flash may support networking capability, whereas a neutral density filter might not have networking support. In various embodiments, the system tracks which camera accessories are compatible with camera 108 and which of those accessories have networking capabilities and which do not.

In some implementations, when network connectivity is unavailable, and the client applications (e.g., camera, mobile device, etc.) cannot communicate with the server, the environment data can be analyzed locally by a pre-loaded machine-learning model.

At block 204, the system receives, at the server 104, environment data. In various implementations, the environment data is associated with the environment surrounding of the camera. For example, the environment data may include a target object or target scene to be captured by the camera. The environment data may include other environment data such as lighting, weather, etc. The system may receive the environment data from the camera. In various implementations, the camera may detect some environment data based on sensors of the camera. In various implementations, the user may enter some environment data into the camera.

In various implementations, the environment data may include not only environmental factors at a given location, but also the time of day. The particular types of environment data may vary, depending on the particular implementation. For example, the environment data may be associated with weather patterns. Various example implementations directed to environment data are described in more detail herein.

In addition to environment data, the user may also enter image preferences. For example, the image preferences may include one or more image styles. In some implementations, the image preferences may include a photographer other than the user. For example, the photographer may be a well-known or famous photographer. Various example implementations directed to these aspects are described in more detail herein.

At block 206, the system provides the capabilities data and the environment data to one or more machine-learning models. In various implementations, a machine-learning model may be associated with AI techniques, and may involve large language model (LLM). With various implementations described herein, the machine-learning model may also be referred to as the AI.

As described herein, the machine-learning model of the AI analyzes digital stills and/or video clips. The machine-learning model, or AI, may determine the current location, interesting features of the location, and may also analyze EXIF data from other photos and/or videos of the location to make suggestions, including candidate camera settings. The AI may compare to other photos/videos of the location to make suggestions. As described in more detail herein, the AI may suggest compositions based on location, time of day, weather, etc. The AI may suggest camera settings, including camera settings based on other artists.

In various implementations, the AI may answer user queries based on location, time of day, proximity to interesting locations, et al. The AI may ask the user questions to aid with suggestions. The question may vary, depending on the particular implementation. Example questions may include the following: How far do you want to hike? What hiking difficulty is okay? What lenses are available? What filters are available?

At block 208, the system receives one or more candidate camera settings from the machine-learning model. In various implementations, the one or more candidate camera settings are based on the environment data. For example, if the environment data indicates that it is dusk, the candidate camera settings may have an exposure setting for taking optimal photos or enhanced photos based on the lighting at the moment.

As indicated above, the user may provide the system with image preferences, where such image preferences my include style such (e.g., old family photos, black and white photos, etc.). Such styles may include styles of a photographer other than the user, which the user like. For example, the photographer may be a well-known or famous photographer. As such, the system may generate candidate camera settings that reflect these preferences.

At block 210, the system displays the one or more candidate camera settings in a user interface of a camera device. In various implementations, the one or more candidate camera settings guide a user in improving a quality level of one or more images captured by the camera device.

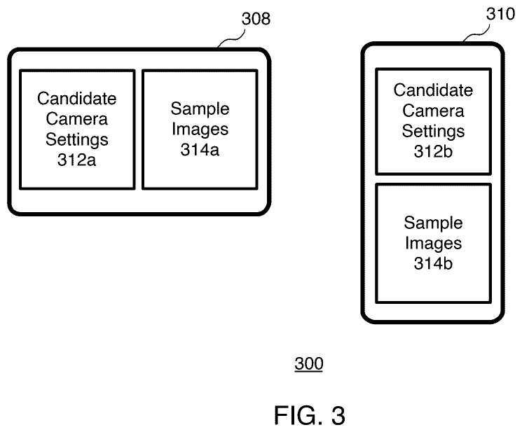

FIG. 3 illustrates example user interfaces for displaying candidate camera parameters and example images, according to some implementations. Shown is a camera 308, which may be used to represent camera 108 of FIG. 1. Also shown is a mobile device 310, which may be used to represent mobile device 112 of FIG. 1.

In various implementations, the system receives the one or more candidate camera settings outputted by the machine-learning model. The candidate camera settings may also be referred to as suggested camera settings, as the candidate camera settings are suggestions or recommendations to the user of the camera.

As shown, the system displays via camera 308 candidate camera settings 312a and sample images 314a. Here, the system displays the candidate camera settings in the user interface of camera 308. The user may then review the candidate camera settings, decide with are desirable, and then select one or more of the candidate camera settings. In various scenarios, the system facilitates the user in learning more about photography, and well as enabling the user to improve his or her photos. As such, the candidate camera settings guide a user in improving the quality level of images captured by the camera device, as well as improving the overall photography experience for the user.

In various implementations, the candidate camera settings may include any settings available on the camera. The system enables the user to enter the make and model number of the camera. The system takes this information to fetch technical specifications of the camera. Such technical specifications may include features and capabilities that are integrated into the camera, as well as optional accessories. For example, in various implementations, the candidate camera settings include lens settings. The suggested or candidate lens settings would be setting that are available with regard the lens of camera.

In some scenarios, a given camera may have optional accessories that the user may purchase to be attached to the camera. In these scenarios, the system may learn from the camera what accessories are available to be added. For example, the camera may communicate to the server what accessories are already available to the camera. There may be some scenarios where a given camera and/or accessory has a barcode (e.g., QR code, etc.), radio-frequency identification (RFID), etc. that the user may scan with a mobile device to convey what accessories are available. In various embodiments, the system may utilize large language model (LLM) techniques and LLM data sources for details on device capabilities.

In various scenarios, the camera may currently have a given accessory such as a particular lens attached. Also, the camera may have had other accessories (e.g., other lenses, filters, etc.) that are not currently attached but may have been previously attached. The system may include some candidate settings that may be user-selected if the user either reconfigures the camera with a particular accessory, whether already owned by the user or to be procured by the user.

The particular candidate camera settings may vary and will depend on the particular implementation. For example, in various implementations, the candidate camera settings may include compositions. In various implementations, the candidate camera settings include one or more flash setups. The candidate settings may be suggestion that are tailored for shooting in particular indoor environments. In various implementations, the candidate camera settings include filter effects. In various implementations, the candidate camera settings include exposure aspects. For example, the exposure aspects may include exposure compensation, long exposure, etc. Different settings described herein may be adjusted to indoor and outdoor environments, depending on the particular implementation. In example use case, the system may determine the best time of day for taking photos of the sun, moon, and Milky Way galaxy events, etc. The system may recommend such times, as well as provide particular candidate camera settings when the user arrives at the location to take photos.

Often the environment of the camera continuously changes. In various implementations, the system continuously monitors the environment data and detects changes to the environment. As such, the system may continuously update and/or provide new candidate camera settings.

For example, if the sun goes down, the lighting would change outdoor environments and associated environment data. This could also change indoor environments with windows and associated environment data.

In various implementations, the system may also display a variety sample images to the user. These samples may be images that reflect each set of candidate camera settings. For example, a given set of candidate camera settings may reflect optimal setting for the given lighting conditions, weather conditions, etc. The machine-learning module may generate different sets of candidate camera settings, where each set has a unique combination of candidate camera settings. As describe in more detail herein, in some implementations, the system may learn that user likes particular photographers, where each photographer has a unique style. The system may provide various same images reflecting the different candidate camera settings from which the user may select.

In various embodiments, the system receives input parameters for camera settings and a creativity level selection from the user. For example, when the system is makes suggestions and enables the user to preview potential image settings, the system may provide the user with a creativity level selector to indicate a desired creativity level setting. The creativity level selector may provide the user with a selection of select degrees of freedom for system when making suggestions. The system may enable the user to select the creativity level in a variety of ways, and the particular technique will depend on the particular implementation. For example. The creativity level selector may be implemented with a sliding bar, buttons, user interface controls in an application, by voice commands, etc.). In various embodiments, the creativity level indicates to the system how closely the system should adhere to any input parameters. An example of creativity may be to introduce Intentional Camera Movement (ICM). The user may do this manually or the camera sensor may be able to perform the task automatically. Another example of creativity may be to take picture from a range from slightly out of focus to grossly out of focus. Another example of creativity may include adding one or more filter such as color filters, graduated neutral-density filter (GND), neutral-density (ND) filters, etc.), or any combination thereof. The system modifies the one or more camera settings based on the predetermined input parameters and the user-selected creativity level.

Optionally, in some scenarios, the user may have a mobile device on hand such as mobile device 310. If so, the system may also display candidate camera settings 312b and sample images 314b in the user interface of mobile device 310. In some scenarios, the screen on a mobile may be easier for the user to view than a camera. By displaying the information on both camera 308 and mobile device 310, the system facilitates the user in viewing such information on an optimal display or display that the user prefers. In various embodiments, the system may enable the user to select candidate camera settings from the mobile device 310, in addition to the camera 308. The candidate camera settings 312a and 312b displayed are the same and may be referred to collectively as candidate camera settings 312. Also, sample images 314a and 314b displayed are the same, and may be referred to collectively as sample images 314.

Referring still to FIG. 2, at block 212, the system modifies the one or more camera settings of the camera device based on the one or more candidate camera settings. In various implementations, the system receives a user selection of the one or more candidate camera settings that are displayed in the user interface of the camera. The system the modifies one or more of the camera settings of the camera based on the user selection.

In various implementations, the system may display sample images in the user interface to aid the user in selecting one or settings. Each sample image reflects a group of candidate camera settings. By the system displaying sample images (e.g., modified versions of the image), the user may better understand the effects of the candidate camera settings. The user may then select one or more of the candidate camera settings that the user desires to be modified. In various implementations, the system may adjust the settings of the camera automatically without user intervention.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

The follow are additional embodiments and use cases. In an example use case, for a novice user, the system may provide candidate camera settings to suggest compositions for a given location based on what other artists (e.g., Ansel Adams) have done, suggest what lens to use, and suggest camera settings based on location, time of day, weather patterns, et al.

In an example use case, for a novice user, the system may provide candidate camera settings to suggest multiple flash setups (i.e., locations and distances) when shooting indoors, filter suggestions for color effects, exposure compensation (CPL and GND), long exposure (ND), and date and time suggestions while visiting locations.

While various implementations are described herein in the context of photos, these implementations and others also apply to video. For instance, the system may apply implementations describe this AI in movie making environments as well. For example, the production team may plan shots based on sunrise and sunset, etc.

In various implementations, the system may receive an image photo that was taken by the camera. In various implementations, the system receives an input image of a scene captured by the camera device. The input image may contain a scene or target object in the scene. The system then compares the input image to one or more other images of the scene that are stored in a database. The other images are accessible by the system and may be stored locally or remotely. The system then modifies one or more of the camera settings of the camera based on the comparison between features.

In various implementations, the system identifies various features of the input image (e.g., lighting, exposure, etc.). The system then compares each of these features to like features in the stored images of the scene. In various implementations, the system builds a database of a growing number of images for comparisons. The system may add images to the database as the user takes new pictures.

In an example use case, the user may use their mobile device to capture an image, which may contain a scene or target object in the scene. The system may receive the image and then analyze the image. The system may then compare the image to similar images taken with the mobile device to images from an LLM image database. The system may then provide candidate camera settings based on settings that were used in similar photos. These candidate camera settings will also reflect the camera capabilities. The system may also automatically configure the camera to the same or similar settings used in the images it identifies. These settings might be identified using exchangeable image file format (EXIF) information that was saved with those images. The system may identify these settings based on other text or other information associated with the similar images it identifies.

As indicated above, although various implementations disclosed herein are described in the context of photos, these implementations may also apply to video. For example, this may enhance the experience of a user using a drone. The system may provide suggested or candidate camera settings for a video camera on the drone.

In various implementations, the system may facilitate a user in planning trips to specific to areas or locations. An advanced user may use the AI of the system to help plan places to visit when visiting new/unfamiliar areas. For example, the user may ask the system “where are all the waterfalls in the Columbia River Gorge area?” The system may provide the locations, as well as optimal best times to visit the waterfalls. In various implementations, the system assembles data from one or more databases to facilitate a good photographic and/or video experience. The system recommends dates and times for visiting a particular location and recommends compositions for the given location.

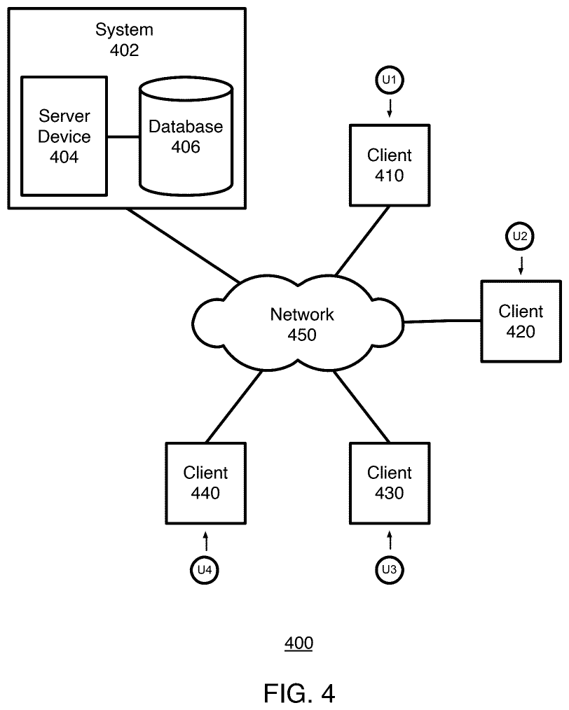

FIG. 4 is a block diagram of an example network environment 400, which may be used for some implementations described herein. In some implementations, network environment 400 includes a system 402, which includes a server device 404 and a database 406. For example, system 402 may be used to implement system 102 and/or server 104 of FIG. 1, as well as to perform implementations described herein. Network environment 400 also includes client devices 410, 420, 430, and 440, which may communicate with system 402 and/or may communicate with each other directly or via system 402. Network environment 400 also includes a network 450 through which system 402 and client devices 410, 420, 430, and 440 communicate. Network 450 may be any suitable communication network such as a Wi-Fi network, Bluetooth network, the Internet, etc.

For ease of illustration, FIG. 4 shows one block for each of system 402, server device 404, and network database 406, and shows four blocks for client devices 410, 420, 430, and 440. Blocks 402, 404, and 406 may represent multiple systems, server devices, and network databases. Also, there may be any number of client devices. In other implementations, environment 400 may not have all the components shown and/or may have other elements including other types of elements instead of, or in addition to, those shown herein.

While server device 404 of system 402 performs implementations described herein, in other implementations, any suitable component or combination of components associated with system 402 or any suitable processor or processors associated with system 402 may facilitate performing the implementations described herein.

In the various implementations described herein, a processor of system 402 and/or a processor of any client devices 410, 420, 430, and 440 cause the elements described herein (e.g., information, etc.) to be displayed in a user interface on one or more display screens.

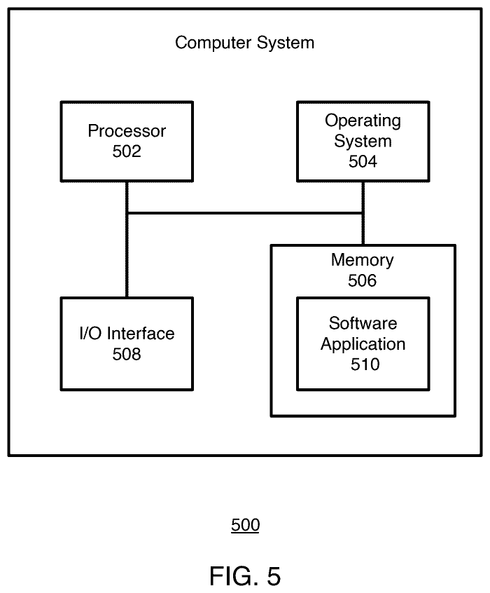

FIG. 5 is a block diagram of an example computer system 500, which may be used for some implementations described herein. For example, computer system 500 may be used to implement server device 404 of FIG. 4 and/or system 102 of FIG. 1, as well as to perform implementations described herein. In some implementations, computer system 500 may include a processor 502, an operating system 504, a memory 506, and an input/output (I/O) interface 508. In various implementations, processor 502 may be used to implement various functions and features described herein, as well as to perform the method implementations described herein. While processor 502 is described as performing implementations described herein, any suitable component or combination of components of computer system 500 or any suitable processor or processors associated with computer system 500 or any suitable system may perform the steps described. Implementations described herein may be carried out on a user device, on a server, or a combination of both.

Computer system 500 also includes a software application 510, which may be stored on memory 506 or on any other suitable storage location or computer-readable medium. Software application 510 provides instructions that enable processor 502 to perform the implementations described herein and other functions. Software application may also include an engine such as a network engine for performing various functions associated with one or more networks and network communications. The components of computer system 500 may be implemented by one or more processors or any combination of hardware devices, as well as any combination of hardware, software, firmware, etc.

For ease of illustration, FIG. 5 shows one block for each of processor 502, operating system 504, memory 506, I/O interface 508, and software application 510. These blocks 502, 504, 506, 508, and 510 may represent multiple processors, operating systems, memories, I/O interfaces, and software applications. In various implementations, computer system 500 may not have all the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C #, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
receiving, at a server, environment data;
providing the environment data to one or more machine-learning models;
receiving one or more candidate camera settings from the one or more machine-learning models, wherein the one or more candidate camera settings are based on the environment data;
displaying the one or more candidate camera settings in a user interface of a camera device, wherein the one or more candidate camera settings guide a user in improving a quality level of one or more images captured by the camera device; and
modifying the one or more camera settings of the camera device based on the one or more candidate camera settings.

2. The system of claim 1, wherein the environment data is associated with one or more of a location and a time of day.

3. The system of claim 1, wherein the one or more candidate camera settings comprise one or more of compositions and lens settings.

4. The system of claim 1, wherein the one or more candidate camera settings comprise one or more flash setups.

5. The system of claim 1, wherein the one or more candidate camera settings comprise one or more of filter effects and exposure aspects.

6. The system of claim 1, wherein the logic when executed is further operable to cause the one or more processors to perform operations comprising:
receiving a user selection of the one or more candidate camera settings that are displayed in the user interface of the camera; and
modifying the one or more camera settings of the camera based on the user selection.

7. The system of claim 1, wherein the logic when executed is further operable to cause the one or more processors to perform operations comprising:
receiving an input image of a scene captured by the camera device;
comparing the input image to one or more other images of the scene that are stored in a database; and
modifying the one or more camera settings of the camera based on the comparing.

8. The system of claim 1, wherein the logic when executed is further operable to cause the one or more processors to perform operations comprising:
receiving a user-selected creativity level from the user; and
modifying the one or more camera settings of the camera based on the user-selected creativity level.

9. A non-transitory computer-readable storage medium with program instructions stored thereon, the program instructions when executed by one or more processors are operable to cause the one or more processors to perform operations comprising:
receiving, at a server, environment data;
providing the environment data to one or more machine-learning models;
receiving one or more candidate camera settings from the one or more machine-learning models, wherein the one or more candidate camera settings are based on the environment data;
displaying the one or more candidate camera settings in a user interface of a camera device, wherein the one or more candidate camera settings guide a user in improving a quality level of one or more images captured by the camera device; and
modifying the one or more camera settings of the camera device based on the one or more candidate camera settings.

10. The computer-readable storage medium of claim 9, wherein the environment data is associated with one or more of a location and a time of day.

11. The computer-readable storage medium of claim 9, wherein the one or more candidate camera settings comprise one or more of compositions and lens settings.

12. The computer-readable storage medium of claim 9, wherein the one or more candidate camera settings comprise one or more flash setups.

13. The computer-readable storage medium of claim 9, wherein the one or more candidate camera settings comprise one or more of filter effects and exposure aspects.

14. The computer-readable storage medium of claim 9, wherein the instructions when executed are further operable to cause the one or more processors to perform operations comprising:
receiving a user selection of the one or more candidate camera settings that are displayed in the user interface of the camera; and
modifying the one or more camera settings of the camera based on the user selection.

15. The computer-readable storage medium of claim 9, wherein the instructions when executed are further operable to cause the one or more processors to perform operations comprising:
receiving an input image of a scene captured by the camera device;
comparing the input image to one or more other images of the scene that are stored in a database; and
modifying the one or more camera settings of the camera based on the comparing.

16. A computer-implemented method comprising:
receiving, at a server, environment data;
providing the environment data to one or more machine-learning models;
receiving one or more candidate camera settings from the one or more machine-learning models, wherein the one or more candidate camera settings are based on the environment data;
displaying the one or more candidate camera settings in a user interface of a camera device, wherein the one or more candidate camera settings guide a user in improving a quality level of one or more images captured by the camera device; and
modifying the one or more camera settings of the camera device based on the one or more candidate camera settings.

17. The method of claim 16, wherein the environment data is associated with one or more of a location and a time of day.

18. The method of claim 16, wherein the one or more candidate camera settings comprise one or more of compositions and lens settings.

19. The method of claim 16, wherein the one or more candidate camera settings comprise one or more flash setups.

20. The method of claim 16, wherein the one or more candidate camera settings comprise one or more of filter effects and exposure aspects.
